(19) United States
(12) Patent Application Publication
(10) Pub. No.: US 2013/0321227 A1
(43) Pub. Date: Dec. 5, 2013

(54) Waveguide Antenna Having Annular Slots

(71) Applicant: Philippe Ratajczak, Nice (FR)

(72) Inventor: Philippe Ratajczak, Nice (FR)

(73) Assignee: ORANGE, Paris (FR)

(21) Appl. No.: 13/985,013

(22) PCT Filed: Feb. 13, 2012
(86) PCT No.: PCT/FR2012/050311

§ 371 Date: Aug. 12, 2013

(30) Foreign Application Priority Data
Feb. 11, 2011 (FR) 1151122

(51) Int. Cl. H01Q 13/18

(52) U.S. Cl. CPC H01Q 13/18
USPC 343/769

(57) ABSTRACT

A slotted waveguide antenna element s provided, which includes at least one conductive surface provided with at least one annular slot, which defines at the central portion thereof a conductive zone and which electrically insulates the zone from the rest of the surface.

### CROSS-REFERENCE TO RELATED APPLICATION

This Application is a Section 371 National Stage Application of International Application No. PCT/FR2012/050311, filed Feb. 13, 2012, which is incorporated by reference in its entirety and published as WO 2012/107705 on Aug. 16, 2012, not in English.

### FIELD OF THE INVENTION

The present invention relates to the field of telecommunications. Within this field, the invention relates more specifically to antennas intended to receive or transmit a telecommunications signal.

The antenna can be used in a variety of systems. Its design based on the slotted guide technique allows it to be used in on-board systems, i.e. on a typically mobile medium such as a train or an aeroplane, for which the size, weight, and power consumption constraints can be extremely strict. The antenna is more specifically suitable for so-called “high-bit-rate” or even “very-high-bit-rate” connections, for example for satellite transmissions in the Ka band, which extends in transmission from 27.5 to 31 GHz and in reception from 18.3 to 18.8 GHz and from 19.7 to 20.2 GHz.

The antenna is composed of basic antennal elements joined along one dimension to form a slotted guide. The antenna may be composed of several slotted guides joined to form an array.

### PRIOR ART

The theory of slots in guides known as slotted guides was initially described by A. F. Stevenson in article [1] in a context of linear polarization alone. The waveguide, which is normally used for the transport of energy, is transformed into a radiating system by cutting out, on one of the surfaces of the generally rectangular guide, judiciously placed slots that are narrow with respect to the wavelength.

FIG. 1a is a diagram showing a basic antennal element with a waveguide with a rectangular slot cut out on one of the surfaces, generally the so-called upper surface which is oriented in the direction of the element in communication with the antenna. The slot is excited by the propagation of the field in the waveguide. To improve performance, the basic antennal elements are joined in series along an axis to form a slotted guide as shown in FIG. 1b, then the slotted guides are joined in parallel to obtain an antenna as shown in FIG. 1C. The use of such a conjunction to form an array is described in Article [2]. The arrangement of the slots as shown in FIGS. 1a-1c gives rise to radiation with a linear polarization.

Certain uses, particularly satellite communications, require depointing of the antenna so that the beam points in the direction of the satellite. A depointing can be obtained mechanically by mechanical movement of the antenna, steered manually or by a motor. Size constraints, for example for on-board systems (installation of an antenna on a train, an aeroplane etc.) forbid any mechanical depointing mechanism. Such depointing must therefore be obtained electronically.

Article [5] describes how to control the radiation of an antenna using SIW technology and how to depoint the beam in the plane of the array formation by feeding each slotted guide in parallel and by controlling the phase of each feed point of the slotted guides.

Given that the difference of polarization between the received signal (polarization connected to the transmission antenna) and the polarization of the reception antenna can lead to an attenuation of the received signal, which can be total if the two polarizations are crossed, it is then necessary to resort to a circular polarization which makes it possible to avoid this phenomenon of total attenuation for certain uses. In particular, such a choice is thus made in cases where the orientation of the “reception” antenna, fixed or mobile, (an antenna which can also act as transmission antenna) must change over time and follow the mobile “transmission” antenna (an antenna which can also act as reception antenna), cases which are encountered with flyby (non-geostationary) satellites or with on-board systems intended to communicate with a satellite.

The obtaining of a circular polarization requires the use of guides with double rectangular slots formed by:
a cross centred with respect to the axis of the guide with two weakly asymmetrical arms,
a cross offset with respect to the axis of the guide as described in [3] and illustrated by FIG. 2a or
two slots offset along the length and the width of the guide and inclined at around 45° as described in [4] and illustrated by FIG. 2b.

The curves in FIG. 2c show the elevational radiation of this type of double-slotted guide corresponding to FIG. 2a or 2b for various planes offset by an angle Phi (0°, 45°, 90°, 135°) with respect to the axis of the guide, this angle Phi being known as angle of bearing. The principal (right-)circularly polarized radiation diagram corresponding to the lines DirRHCP is characterized by a maximum in the direction perpendicular to the surface in which the slots are found. The lines DirLHCP show the radiation in (left) cross-polarization. An adjustment of the dimensions, positions and inclinations of the slots makes it possible to obtain a low level of cross-polarization in the direction of the radiation maximum. Nonetheless, off this axis, the level of the cross-polarization rises again rapidly and reaches the level of the principal polarization, in the environs of 40°, according to the illustration in FIG. 2c. This rise is mainly due to the geometry of the slots, which individually generate asymmetrical E- and H-planes which, after recombination in amplitude and in phase, create a high level of circular cross-polarization outside the axis.

This high level of cross-polarization limits the performance of antennas based on a guide with rectangular slots when used with a depointing of the beam. In fact, when the beam is depointed at a given angle, the level of cross-polarization of the beam is that of the basic element. Thus, in the case of the example illustrated by FIG. 2c, if the depointing angle of the beam is fixed at 40° then the level of cross-polarization is equivalent to that of the principal polarization. Such antenna behaviour is prohibitive for a use requiring a large separation between principal and cross-polarization.

### SUMMARY

The invention proposes an antennal element with a slotted waveguide, which is an alternative to known antennal elements, with equivalent performance or even better performance for certain configurations.

Thus, the subject of the invention is an antennal element with a slotted waveguide containing at least one conductive surface provided with at least one annular slot which delimits a conductive region in its central part and which electrically insulates this region from the rest of the surface.

Such an antennal element is typically obtained using SIW (Substrate Integrated Waveguide) technology. This technology makes it possible to obtain the slots by printing. The annular shape of the slot makes it possible to obtain an equivalent or even more advantageous performance than the rectangular shape in certain configurations, while simplifying the fabrication process, in particular in cases where a circular polarization must be obtained. In fact, in these cases, the printing mask only contains one annular slot whereas according to the prior art at least two rectangular slots are necessary, with constraints on the positioning of one slot with respect to the other.

According to an embodiment of the invention, the antennal element is such that the annular slot is offset with respect to the axis of the slotted guide.

A slotted guide has a shape that is generally close to that of a parallelepiped, therefore characterized at least by one length. The length is the dimension along the axis of the parallelepiped. The offset of the annular slot with respect to the axis makes it possible advantageously to obtain a circular polarization. Thus, with respect to the prior art, only the offset of the printing mask with respect to the axis is necessary to obtain circular polarization. According to the prior art, the fabrication of an antennal element with a slotted guide which is of rectilinear polarization or circular polarization requires a different mask specific to the polarization. In fact, for obtaining a circular polarization according to the prior art a double rectangular slot is necessary, with a particular arrangement of the double slot. That is to say, either the double slot consists in a cross centred with respect to the axis of the guide with two weakly asymmetrical arms, or the double slot consists in a cross offset with respect to the axis of the guide, or the double slot consists in two slots offset along the length and the width of the guide and inclined at around 45°. Contrary to the prior art, which therefore requires the mask to be changed as a function of the desired polarization, one and the same mask makes it possible to obtain an antennal element according to the invention with either a rectilinear or a circular polarization, and this solely by offsetting the mask on the surface of the substrate on which the slot must be printed. The antennal element according to the invention generates radiation in circular polarization with an insulation between the principal polarizations and the cross polarizations for angles above 40° that is much larger than that obtained with rectangular slots. Notably, in the plane perpendicular to the axis of the slotted guide, this insulation can reach levels of over 15 dB whereas with an antennal element of the prior art this insulation is quasi-imperceptible. This notable difference expresses the fact that an antennal element according to the invention is particularly better-suited to uses where a depointing is necessary, as in the case of a transmission between a mobile medium such as a train or an aeroplane, and a satellite, than the known antennal elements.

According to an embodiment of the invention, the antennal element is such that the distance between the inner and outer edges of the annular slot is subject to notable variations along the perimeter of the slot, which delimit stubs.

The stubs typically have the shape of notches in the case of an annular slot of circular shape, or the shape of triangles in the case of an annular slot of square shape. These stubs are made on the central region along the inner edge of the slot or on the outer part along the outer edge of the slot, which part belongs to the rest of the surface. These stubs act as perturbations which modify the symmetry of the slot. Thus, even if the slot is fixed on the axis of the slotted guide, the stubs make it possible to obtain a circular polarization. If the slot is offset with respect to the axis of the slotted guide, the stubs make it possible to modify the radiation and to limit the frequency band with respect to the same slot without stubs.

The various preceding embodiments can be combined together, or not, to define another embodiment.

According to an embodiment of the invention, the antennal element is such that the distance between the inner and outer edges of the annular slot is variable along the perimeter of the slot.

The variation of the width of the annular slot can result for example from the fact that the inner and outer edges of the slot are not concentric. This asymmetry makes it possible advantageously to modify the radiation of the slot with respect to the same element with an invariable distance between the two edges of the slot.

This last embodiment can be combined or not with a preceding embodiment to define another embodiment.

According to an embodiment of the invention, the antennal element comprises another annular slot surrounding the annular slot.

The presence of a second annular slot of which the central part includes the first annular slot makes it possible to obtain a dual-band antennal element. The antennal element is said to have double annular slots. In the case where the annular slots are circular, the two annular slots are typically centred on a same central point.

This last embodiment can be combined or not with a preceding embodiment to define another embodiment.

The invention moreover has as subject a slotted guide comprising several antennal elements in accordance with the preceding subject, arranged together in a linear array.

The parallelepipedal shape of the antennal elements makes it possible to produce a linear array easily by setting them out in series. The series formation makes it possible to obtain an array with better performance than that of a single antennal element.

The invention moreover has as subject a planar antenna comprising several slotted guides in accordance with the preceding subject, arranged together in a two-dimensional array.

An antenna according to the invention combines a small size and radiation performance compatible with a use with depointing, which requires a large separation between principal and cross-polarization off the principal axis.

According to an embodiment of the invention, the planar antenna comprises a means for feeding the slotted guides in parallel, this means being arranged for steering the phases between the feed signals of the slotted guides.

The control of the phases between each feed point of the slotted guides makes it possible to control their relative dephasing and therefore to maximize the overall radiation with a controlled depointing.

### LIST OF FIGURES

Other features and advantages of the invention will appear in the following description offered with regard to the appended figures, given by way of non-limiting examples.

FIG. 1a is a diagram showing an antennal element according to the prior art.

FIG. 1b is a diagram showing a slotted guide according to the prior art produced with an assembly of the antennal elements in FIG. 1a.

FIG. 1c is a diagram showing an antenna according to the prior art consisting in an array of the slotted guides in FIG. 1b.

FIG. 2a) is an antennal element of the prior art with rectangular slots laid out in crosses offset from the axis of the slotted guide, making it possible to obtain a circular polarization.

FIG. 2b) is an antennal element of the prior art with rectangular slots offset along the length and the width of the slotted guide and inclined at around 45°, making it possible to obtain a circular polarization.

FIG. 2c) shows elevational directivity curves in right-circular (DirRHCP) and left-circular (DirLHCP) polarization at the frequency of 9 GHz of the antennal element of FIG. 2b) for various angles of bearing Phi.

FIG. 3a is a diagram showing an embodiment of an antennal element according to the invention.

FIG. 3b brings together curves of elevational directivity in linear polarizations along x (DirL) and along y (DirR) at the frequency of 8.55 GHz of the antennal element corresponding to FIG. 3a for various planes offset by an angle of bearing Phi.

FIG. 4a is a diagram showing an embodiment of an antennal element according to the invention, in which the slot of annular shape is offset with respect to the axis of the slotted guide.

FIG. 4b brings together curves of elevational directivity in right-circular (DirRHCP) and left-circular (DirLHCP) polarizations at the frequency of 9.9 GHz of the antennal element corresponding to FIG. 5a for various planes offset by an angle of bearing Phi.

FIG. 4c gives the curve of the ellipticity ratio of the antennal element of FIG. 5a.

FIG. 5a is a diagram showing an embodiment of an antennal element according to the invention, in which the distance between the inner and outer edges of the slot is subject to notable variations along the perimeter of the slot, which delimit stubs at the metal central part.

FIG. 5b brings together curves of elevational directivity in right-circular (DirRHCP) and left-circular (DirLHCP) polarizations at the frequency of 9.8 GHz of the antennal element corresponding to FIG. 5a for various planes offset by an angle of bearing Phi.

FIG. 5c gives the curve of the ellipticity ratio of the antennal element in FIG. 5a.

FIG. 5d is a diagram showing an embodiment of an antennal element according to the invention, in which the distance between the inner and outer edges of the slot is subject to notable variations along the perimeter of the slot, which delimit stubs in the rest of the surface (part outside the slot).

FIG. 6a is a diagram showing an embodiment of an antennal element according to the invention, in which the element contains a double annular slot.

FIG. 6b brings together curves of elevational directivity in right-circular (DirRHCP) and left-circular (DirLHCP) polarizations at the frequency of 8.7 GHz of the antennal element corresponding to FIG. 6a for various planes offset by an angle of bearing Phi.

FIG. 6c gives the curve of the ellipticity ratio of the antennal element in FIG. 6a.

FIG. 7 illustrates an embodiment of an antennal element according to the invention with an annular slot of elliptic shape.

FIG. 8a illustrates an embodiment of an antennal element according to the invention, with an annular slot of square shape.

FIG. 8b brings together curves of elevational directivity in linear polarizations along x (DirR) and along y (DirL) at the frequency of 10 GHz of the antennal element corresponding to FIG. 8a for various planes offset by a bearing angle Phi.

FIG. 9a is a diagram showing an embodiment of an antennal element according to the invention, in which the annular slot of square shape is offset with respect to the axis of the slotted guide.

FIG. 9b brings together curves of elevational directivity in right-circular (DirRHCP) and left-circular (DirLHCP) polarizations at the frequency of 10 GHz of the antennal element corresponding to FIG. 9a for various planes offset by a bearing angle Phi.

FIG. 9c gives the curve of the ellipticity ratio of the antennal element in FIG. 9a.

FIG. 10a is a diagram showing an embodiment of an antennal element according to the invention, in which the annular slot of square shape is offset with respect to the axis of the slotted guide and has undergone a rotation so as to finally obtain an annular slot having the shape of a lozenge.

FIG. 10b brings together curves of elevational directivity in right-circular (DirRHCP) and left-circular (DirLHCP) polarizations at the frequency of 10 GHz of the antennal element corresponding to FIG. 10a for various planes offset by a bearing angle Phi.

FIG. 10c gives the curve of the ellipticity ratio of the antennal element in FIG. 10a.

FIG. 11a corresponds to the case of an annular slot of square shape which comprises two perturbaters in the form of symmetrically-placed truncated inner corners.

FIG. 11b brings together curves of elevational directivity in right-circular (DirRHCP) and left-circular (DirLHCP) polarizations at the frequency of 10 GHz of the antennal element corresponding to FIG. 11a for various planes offset by a bearing angle Phi.

FIG. 11c gives the curve of the ellipticity ratio of the antennal element in FIG. 11a.

FIG. 12 illustrates an embodiment of an antennal element according to the invention, in which the distance d between the inner and outer edges of the annular slot is variable along the slot perimeter.

FIG. 13 illustrates a planar dielectric substrate comprising a series of metal holes linking the two metal surfaces of the substrate before cutting out of an annular slot according to the invention on the upper surface.

FIG. 14 is a diagram showing an embodiment of an antennal element according to the invention, obtained by implementing a conventional technology with a metal waveguide coated or uncoated with a dielectric material.

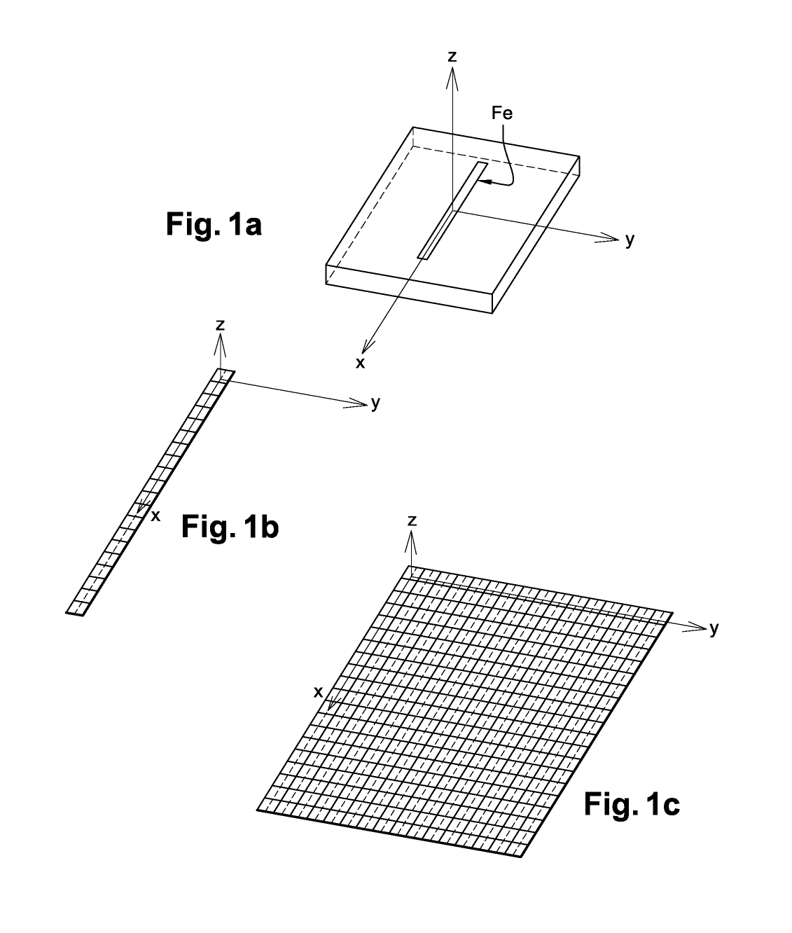

### DESCRIPTION OF AN EMBODIMENT OF THE INVENTION

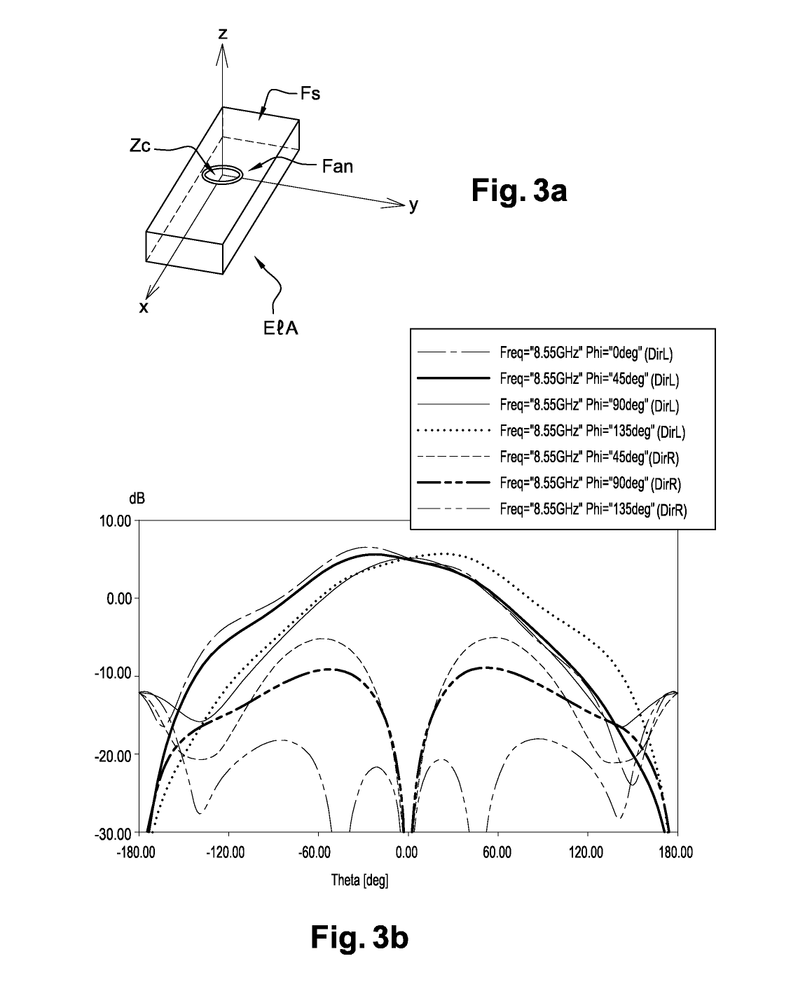

FIG. 3a is a diagram showing an embodiment of an antennal element E1A according to the invention. The antennal element E1A with a slotted guide according to the invention contains at least one conductive surface Fs provided with at least one annular slot Fan. Within the meaning of the invention an annular slot is a slot, which has the peculiarity of delimiting a conductive central region Zc and of electrically insulating it from the rest of the conductive upper surface Fs.

The annular slot is delimited by an inner edge and an outer edge separated by a distance d. The depth of the slot is at least that of the thickness of the metal layer of the upper surface Fs so as to electrically insulate the central region Zc from the rest of the surface Fs.

The curves in FIG. 3b show the elevational radiation of this antennal element corresponding to FIG. 3a for various planes offset by an angle of bearing Phi (0°, 45°, 90°, 135°) with respect to the axis of the guide. The diagram of radiation in principal linear polarization (along x) corresponding to the lines DirL is characterized by a maximum in the direction perpendicular to the surface on which the slot is found. The lines DirR show the radiation in linear cross-polarization (along y).

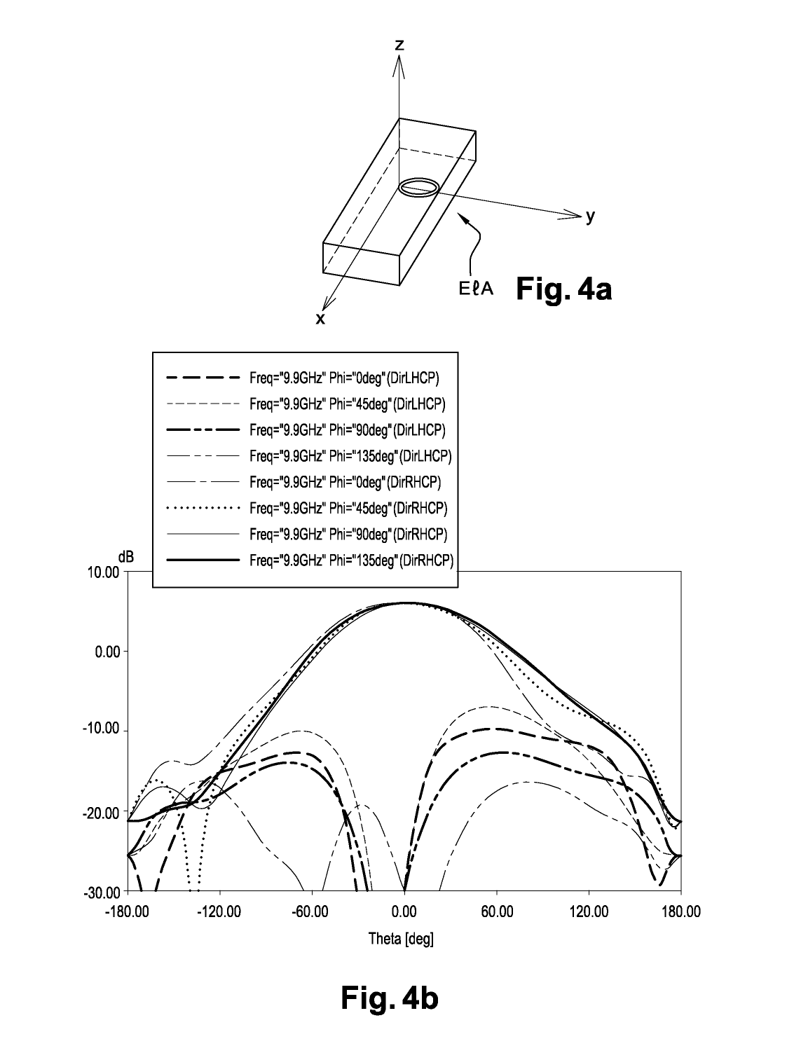

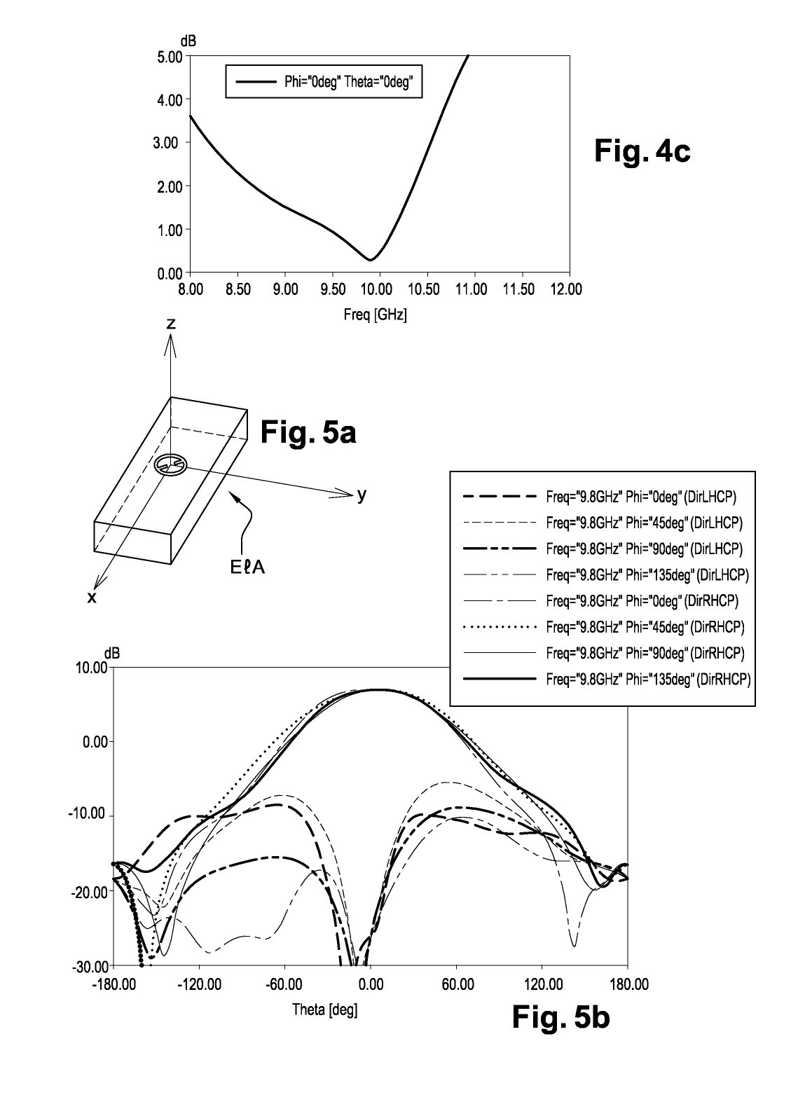

FIG. 4a is a diagram showing an embodiment of an antennal element E1A according to the invention, in which the slot of annular shape is offset with respect to the axis of the slotted guide. The offset with respect to the axis of the slotted guide makes it possible to obtain a circular polarization.

The curves in FIG. 4b show the elevational radiation of this antennal element corresponding to FIG. 4a for various planes offset by a bearing angle Phi (0°, 45°, 90°, 135°) with respect to the axis of the guide. The diagram of radiation in principal (right-) circular polarization corresponding to the lines DirRHCP is characterized by a maximum in the direction perpendicular to the surface on which the slot is found. The lines DirLHCP show the radiation in (left-) circular cross-polarization.

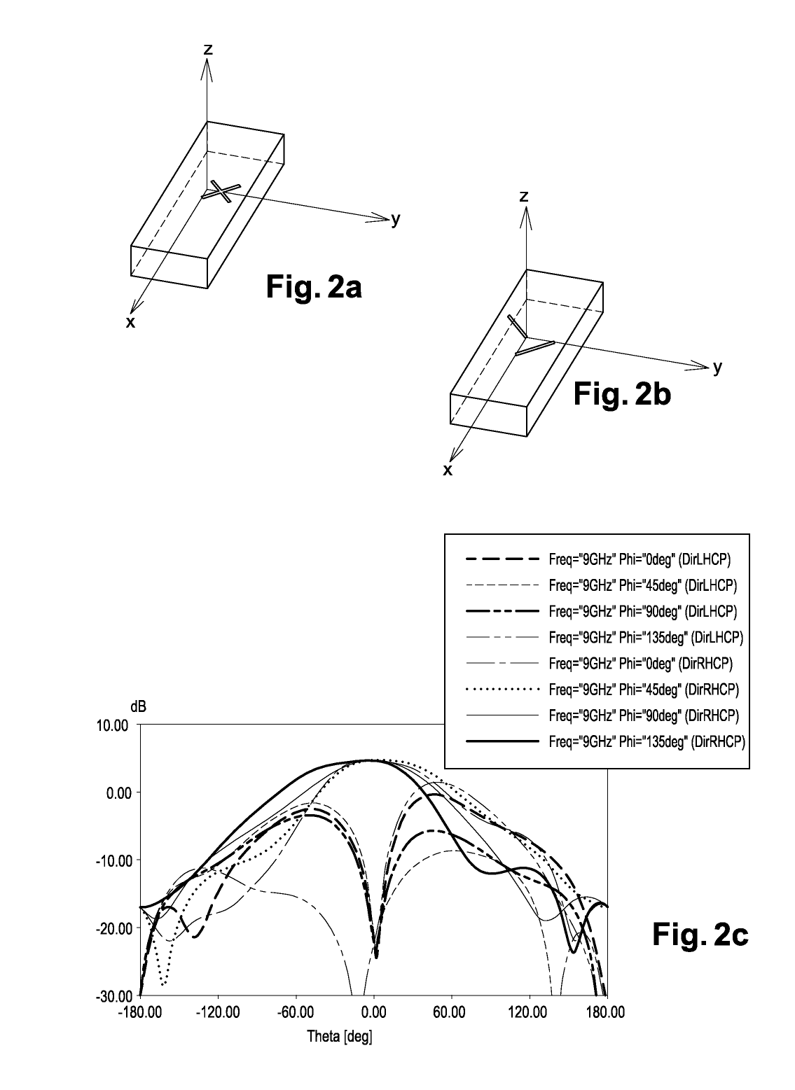

The curves in FIG. 4b make it possible to illustrate the large increase in insulation between the principal and cross-polarizations for angles greater than 40° obtained with an antennal element with an annular slot according to the invention, with respect to an antennal element of the prior art with rectangular slots, the radiation of which is illustrated by FIG. 2c. Notably, in the plane perpendicular to the axis of the guide (Phi=90°) this insulation makes it possible to reach levels of over 15 dB whereas in FIG. 2c this insulation is at best 3 dB.

This notable improvement allows the use of the antennal element according to the invention for uses, which require a certain depointing.

The offset of the annular slot with respect to the axis of the guide makes it possible to generate a right-circular polarization if the slot is to the left following the propagation of the field and vice versa.

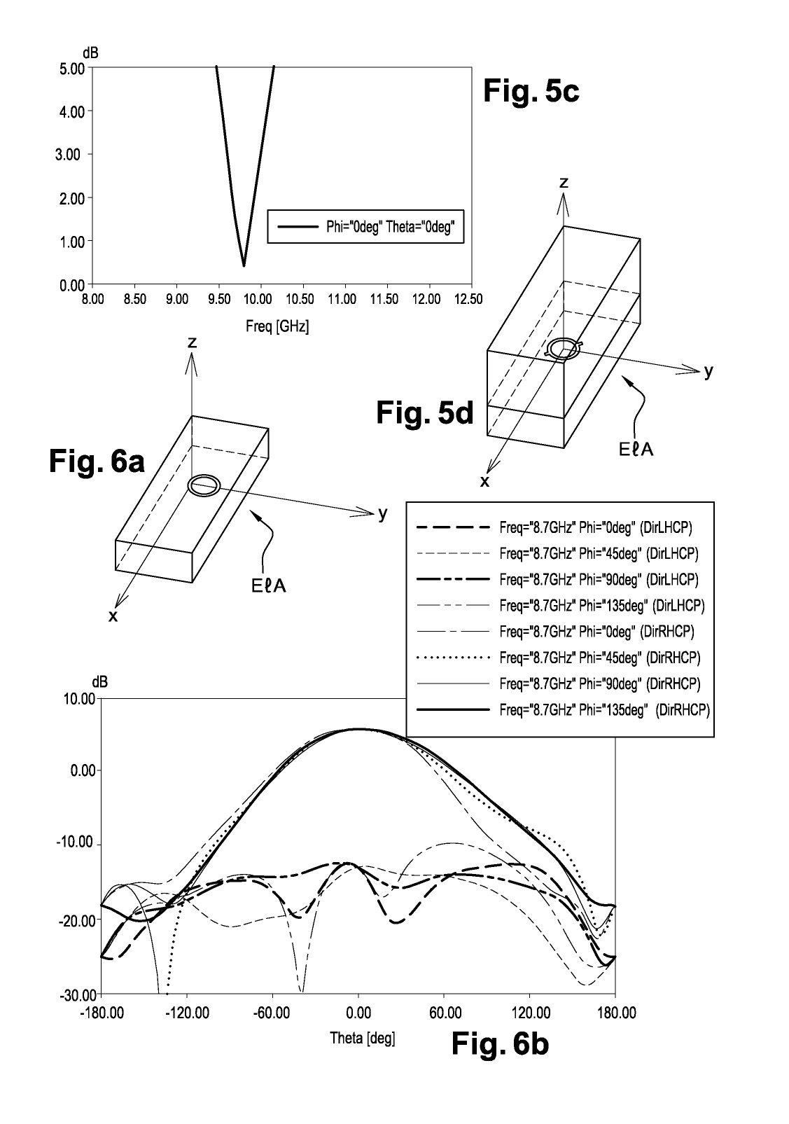

FIG. 5a is a diagram showing an embodiment of an antennal element E1A according to the invention, in which the distance between the inner and outer edges of the slot are subject to notable variations along the perimeter of the slot, which delimit stubs at the metal central part. According to another embodiment illustrated by FIG. 5d, the stubs are made on the outer contour of the slot. These stubs act as perturbations which make it possible to modify the symmetry of the annular slot and to obtain a circular polarization even if the slot is fixed on the axis of the slotted guide. FIG. 5a corresponds to the case of an annular slot of circular shape, which comprises two perturbations in the form of symmetrically-placed notches.

The curves in FIG. 5b show the elevational radiation of this antennal element corresponding to FIG. 5a for various planes offset by a bearing angle Phi (0°, 45°, 90°, 135°) with respect to the axis of the guide. The diagram of radiation in principal (right-) circular polarization corresponding to the lines DirRHCP is characterized by a maximum in the direction perpendicular to the surface in which the slot is found. The lines DirLHCP show the radiation in (left-) circular cross-polarization. Given that the stubs make it possible to modify the radiation and to limit the frequency band with respect to the same slot without stubs, a limitation which becomes apparent when comparing the curve of the ellipticity ratios in FIGS. 4c and 5c, the choice between the embodiment with stubs and the embodiment without stubs can be guided by the operating frequency band desired.

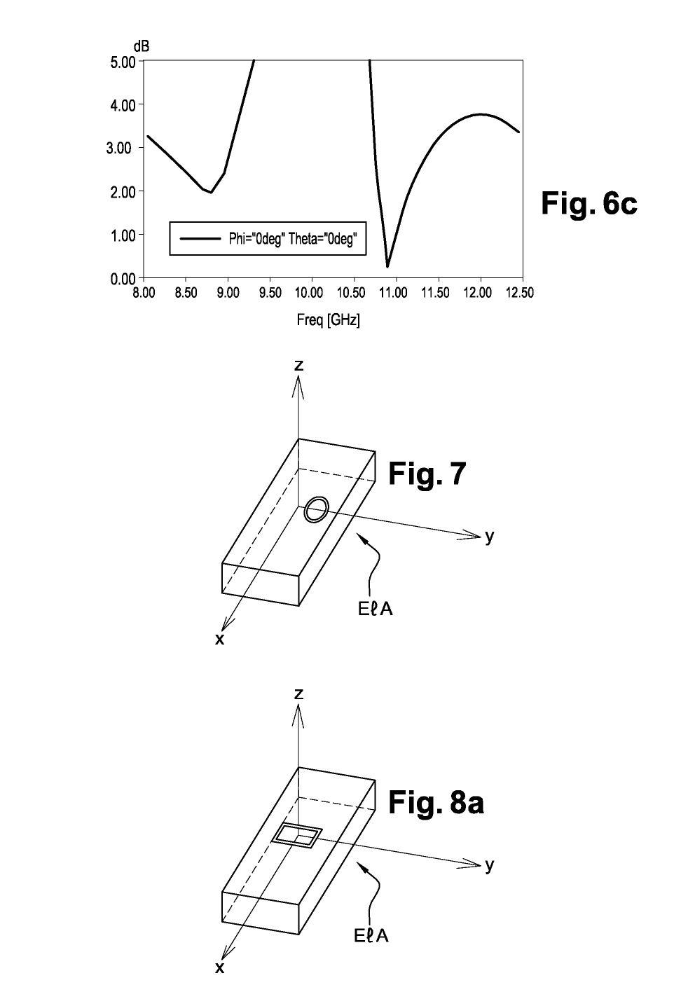

FIG. 6a is a diagram showing an embodiment of an antennal element E1A according to the invention, in which the element contains a double annular slot which makes it possible advantageously to obtain dual-band operation. According to the illustration, the double annular slot has a circular shape. In this case, the two slots are typically centred on a same central point.

The curves in FIG. 6b show the elevational radiation of this antennal element corresponding to FIG. 6a for various planes offset by a bearing angle Phi (0°, 45°, 90°, 135°) with respect to the axis of the guide. The diagram of radiation in principal (right-) circular polarization corresponding to the lines DirRHCP is characterized by a maximum in the direction perpendicular to the surface in which the double slot is found. The lines DirLHCP show the radiation in (left-) circular cross-polarization.

The dual-band operation is revealed by FIG. 6c of the ellipticity ratio, which exhibits two troughs.

The annular slot can have very variable shapes which are similar to the shape of a ring. The shape can be regular and belong to the list comprising circular, oval, elliptical, square, and rectangular shapes.

FIG. 7 illustrates an embodiment of an antennal element according to the invention, with an annular slot of elliptical shape.

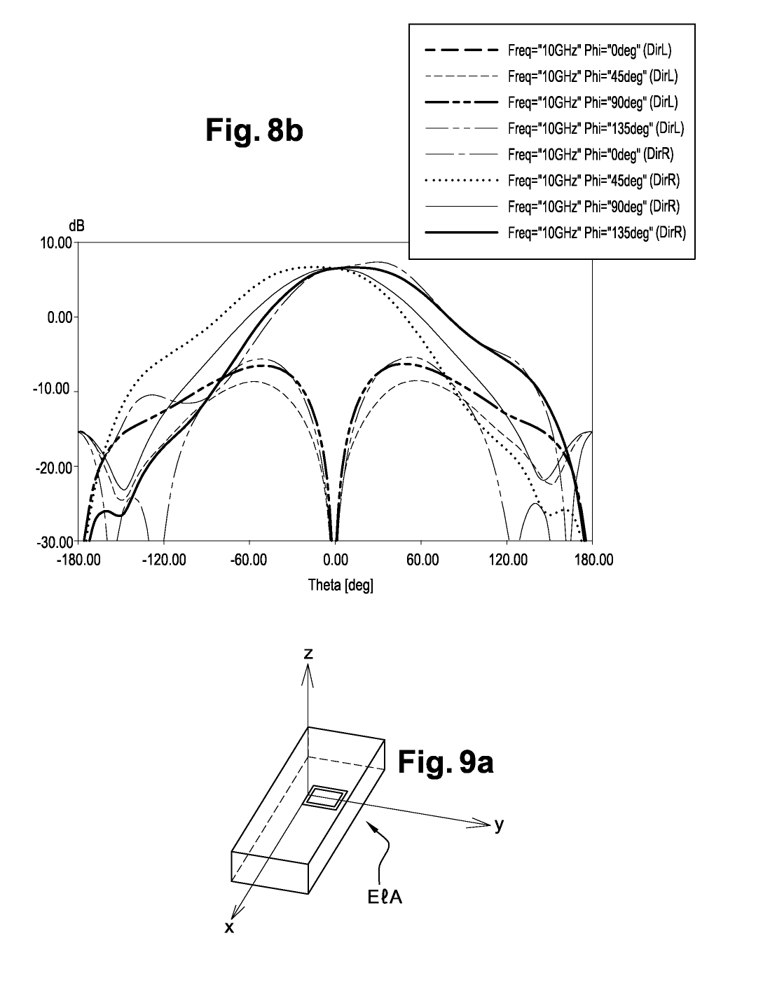

FIG. 8a illustrates an embodiment of an antennal element according to the invention, with an annular slot of square shape.

The curves in FIG. 8b show the elevational radiation of this antennal element corresponding to FIG. 8a for various planes offset by a bearing angle Phi (0°, 45°, 90°, 135°) with respect to the axis of the guide. The diagram of linear principal polarization (along x) corresponding to the lines DirR is characterized by a maximum in the direction perpendicular to the surface in which the slots are found. The lines DirL show the radiation in linear cross-polarization (along y).

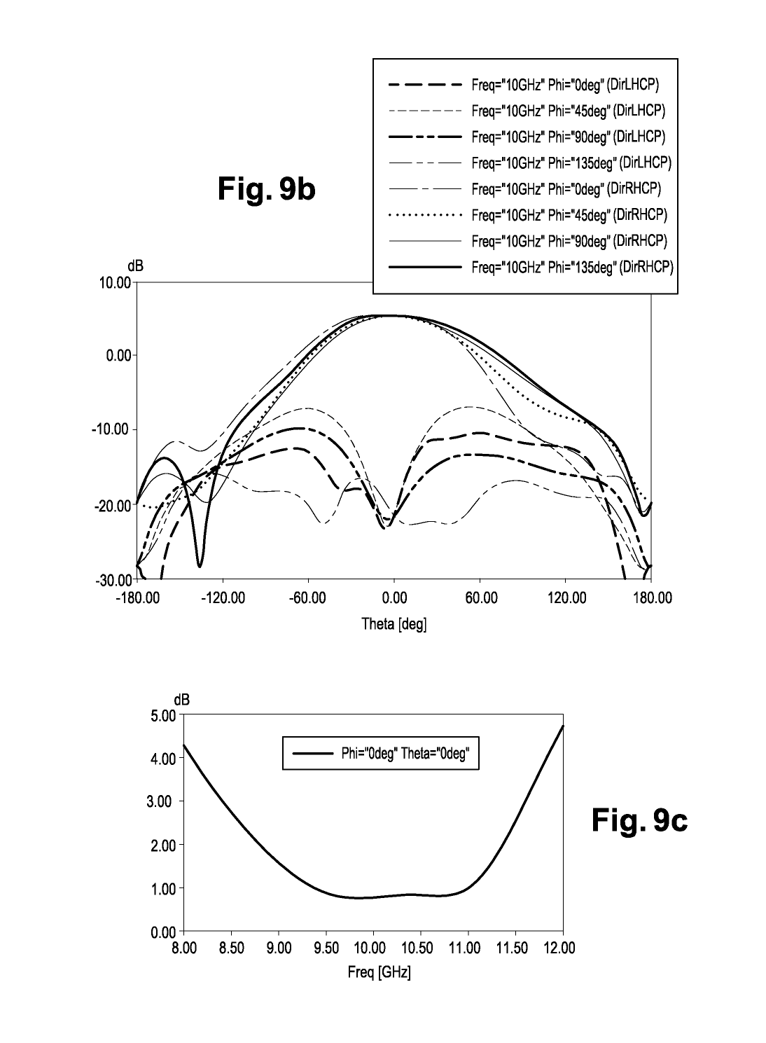

FIG. 9a is a diagram showing an embodiment of an antennal element E1A according to the invention, in which the annular slot of square shape is offset with respect to the axis of the slotted guide. The offset with respect to the axis of the slotted guide makes it possible to obtain a circular polarization.

The curves in FIG. 9b show the elevational radiation of this antennal element corresponding to FIG. 9a for various planes offset by a bearing angle Phi (0°, 45°, 90°, 135°) with respect to the axis of the guide. The diagram of radiation in principal (right-) circular polarization corresponding to the lines DirRHCP is characterized by a maximum in the direction perpendicular to the surface in which the slot is found. The lines DirLHCP show the radiation in (left-) circular cross-polarization.

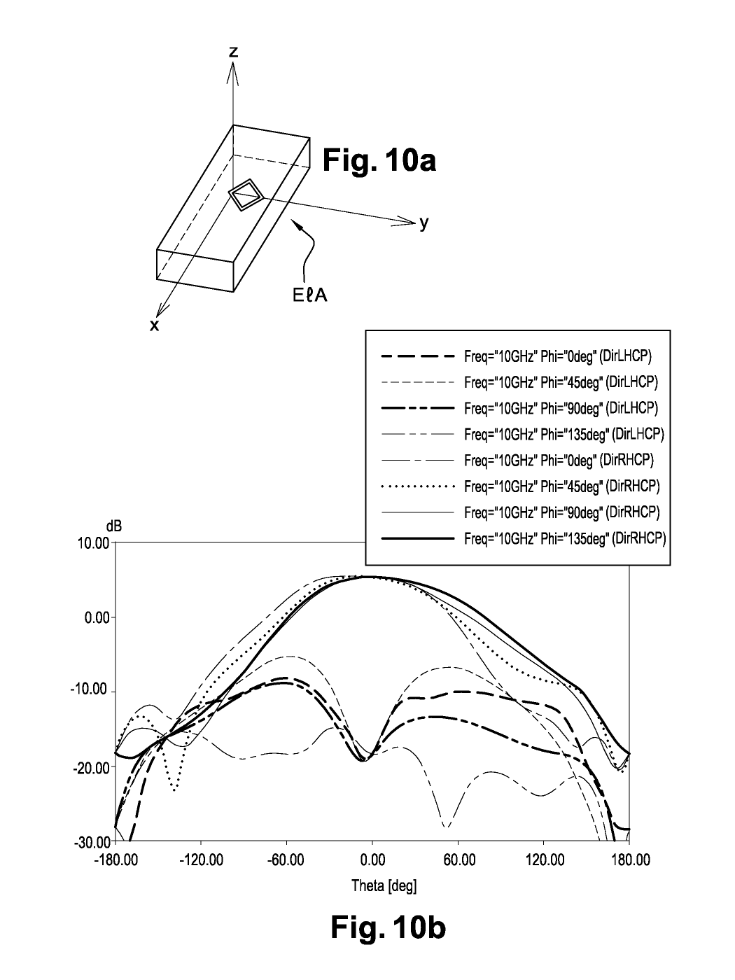

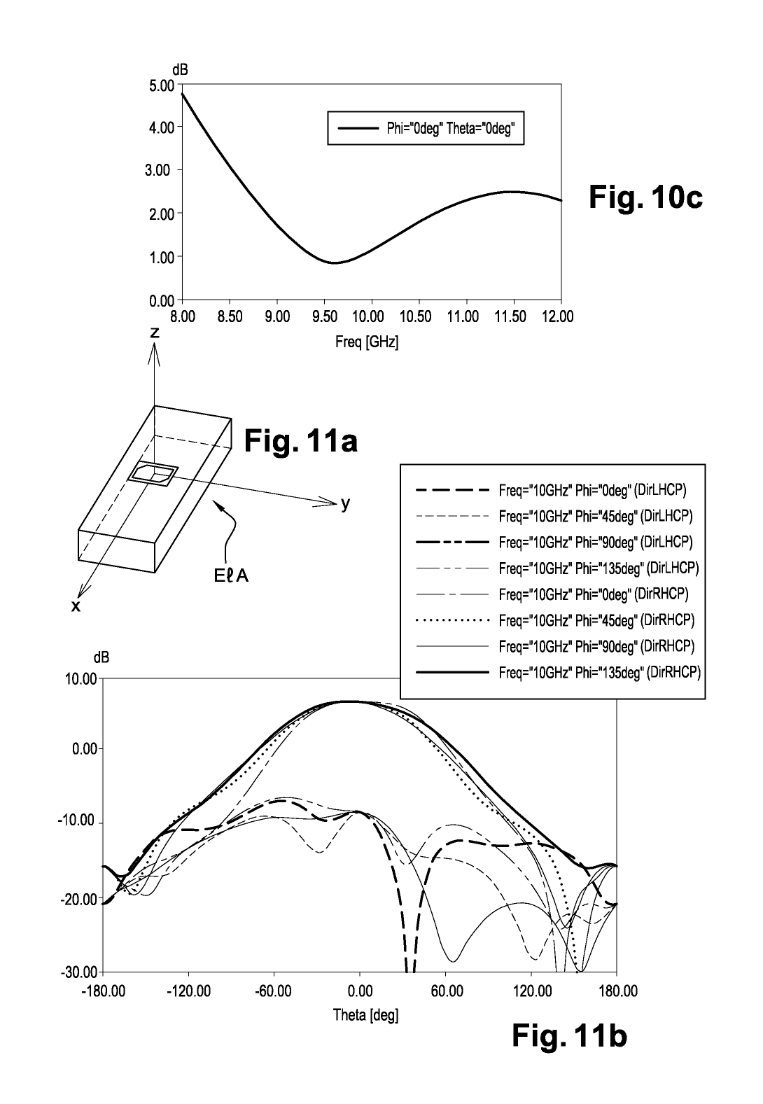

FIG. 10a is a diagram showing an embodiment of an antennal element E1A according to the invention, in which the annular slot of square shape is offset with respect to the axis of the slotted guide and has undergone a rotation so as to finally obtain an annular slot having the shape of a lozenge. The offset with respect to the axis of the slotted guide makes it possible to obtain a circular polarization.

The curves in FIG. 10b show the elevational radiation of this antennal element corresponding to FIG. 10a for various planes offset by a bearing angle Phi (0°, 45°, 90°, 135°) with respect to the axis of the guide. The diagram of radiation in principal (right-) circular polarization corresponding to the lines DirRHCP is characterized by a maximum in the direction perpendicular to the surface in which the slot is found. The lines DirLHCP show the radiation in (left-) circular cross-polarization.

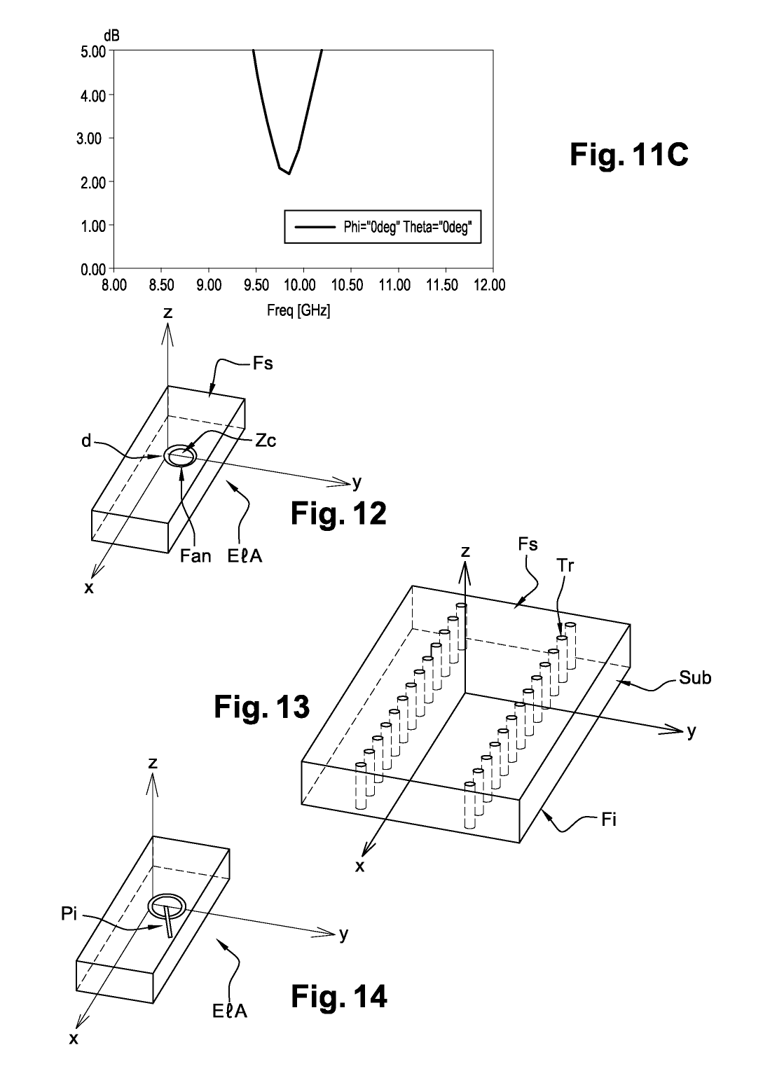

FIG. 11a is a diagram showing an embodiment of an antennal element E1A according to the invention, in which the distance between the inner and outer edges of the slot is subject to notable variations along the perimeter of the slot, which delimit stubs on the metallic central part, or according to another embodiment on the outer contour of the slot. These stubs act as perturbations which make it possible to modify the symmetry of the annular slot and to obtain a circular polarization even if the slot is fixed as the axis of the slotted guide. FIG. 11a corresponds to the case of an annular slot of square shape which comprises two perturbations in the form of symmetrically-placed truncated inner corners.

The curves in FIG. 11b show the elevational radiation of this antennal element corresponding to FIG. 11a for various planes offset by a bearing angle Phi (0°, 45°, 90°, 135°) with respect to the axis of the guide. The diagram of radiation in principal (right-) circular polarization corresponding to the lines DirRHCP is characterized by a maximum in the direction perpendicular to the surface in which the slot is found. The lines DirLHCP show the radiation in (left-) circular cross-polarization.

The shape of the annular slot can just as well be irregular and exhibit a variable distance d between these edges, the shape can for example be potato-like.

FIG. 12 illustrates an embodiment of an antennal element according to the invention, in which the distance d between the inner and outer edges of the annular slot is variable along the perimeter of the slot. A particular embodiment consists in making an annular slot with two circular and non-concentric inner and outer edges as illustrated by FIG. 12.

Whatever the shape of the annular slot, its thickness or depth is such that the metal layer of the surface Fs on which the slot is printed is retracted on the space occupied by the slot Fan. In other words, the slot breaks the electrical continuity, which existed on the surface Fs hosting the slot. Thus, the annular slot delimits two regions on the surface Fs: the region lying inside the slot or region Zc central to the slot, delimited by the inner edge of the slot, and the region outside the slot or the rest of the surface, delimited by the outer edge of the slot. These two regions, which form part of the surface, are electrically insulated from each other by the annular slot.

The annular slot can be obtained by implementing SIW technology. SIW technology as described in [6] makes it possible to produce waveguides from planar dielectric substrates. This technology typically implements a conventional technique for the production of Printed Circuit Boards (or PCBs). As illustrated by FIG. 13, the two metal surfaces Fs, Fi of the substrate Sub form the long upper and lower sides of the guide. The upper side Fs is typically the side which is oriented in the direction of the transmitted or received signal. The vertical metal walls of the short sides of the guide are produced by a series of metal holes Tr connecting the two metal surfaces Fs, Fi of the substrate. This printed technology is advantageous because it makes it possible to produce thin, low-cost antennas as described in [5].

Such a technology is particularly well-suited for obtaining an antennal element with an annular slot in accordance with the invention, since it makes it possible to produce annular slots by printing their pattern on a surface of the antennal element. Such a printing technique is well known to those skilled in the art, known for example as PCB, and is therefore not described. As the outcome of the PCB process the annular slot delimits a central region and electrically insulates it from the rest of the upper surface.

FIG. 14 is a diagram showing an embodiment of an antennal element E1A according to the invention, obtained by implementing a conventional technology with a metal waveguide coated or uncoated with dielectric material. In the case where the waveguide is uncoated the central part is kept on the lower surface using a pin or stud Pi which can be made of dielectric and possibly metal.

The antennal elements according to the invention can be joined along one dimension, in the same way as the antennal elements of the prior art, to form a slotted guide. These latter slotted guides can themselves be joined together in an array, in the same way as the slotted guides of the prior art, to form a planar antenna.

The antenna can be joined to a means for feeding the slotted guides in parallel. The steering of the relative phases between the feed points of the slotted guides makes it possible to maximize the overall radiation and therefore to control the depointing of the antenna.
[1] A. F. Stevenson, <<Theory of slots in rectangular waveguides>>, Journal of applied Physics, vol. 19, pp 24-28, January 1948.
[2] R. S. Elliot, L. A. Kurtz, “The design of small Slot Arrays”, IEEE trans. AP, vol. 26, n° 2, pp 214-219, March 1978.
[3] A. J. Simmons, “Circularly Polarized Slot Radiators” IRE trans AP, Vol. 5, n° 1, PP31-36, January 1957.
[4] G. Montisci, M. Musa, G. Mazzarella, “Waveguide Slot Antennas for Circularly Polarized Radiated Field”, IEEE trans. AP, vol. 52, n° 2, pp 619-623, February 2004.
[5] Y. J. Cheng, W. Hong, K? Wu, Z. Q. Kuai, C. Yu, J. X. Chen, J. Y. Zhou, H. J. Tang, Substrate Integrated Waveguide (SIW) Rotman Lens and Its Ka-Band Multibeam Array Antenna Applications“, IEEE trans. AP, vol. 56, n° 8, pp 2504-2513, August 2008.
[6] K. Wu, D. Deslandes, Y. Cassivi, “The Substrate Integrated Circuit—A New Concept for High-Frequency Electronics and Optoelectronics” Proc. 6th Int. Conf. Telecomm. Modern Satellite, Cable and Boadcasting Service, Vol. 1, pp 3-5, October 2003.

1. An antennal element of slotted waveguide type, comprising:
a waveguide comprising a conductive surface provided with at least one slot excited by propagation of a field in the waveguide, which delimits in its central part a conductive region and electrically insulates this region from the rest of the conductive surface, wherein the slot is annular.

2. The antennal element as claimed in claim 1, in which the annular slot is offset with respect to an axis of the waveguide.

3. The antennal element (E1A) as claimed in claim 1, in which the annular slot comprises inner and outer edges and along a perimeter of the slot within a distance between the inner and outer edges of the annular slot is subject to variations along a perimeter of the slot, variations which delimit stubs on the central part or on an outer contour of the slot.

4. The antennal element as claimed in claim 1, in which the annular slot comprises inner and outer edges and a distance between the inner and outer edges of the annular slot is variable along a perimeter of the slot.

5. The antennal element as claimed in claim 1, containing at least one other annular slot surrounding the annular slot.

6. A slotted guide comprising:
several antennal elements arranged together in a linear array, wherein each of the several antennal elements comprises:
a waveguide comprising a conductive surface provided with at least one slot excited by propagation of a field in the waveguide, which delimits in its central part a conductive region and electrically insulates this region from the rest of the conductive surface, wherein the slot is annular.

7. A planar antenna comprising:
several slotted guides arranged together in a two-dimensional array, each of the slotted guides comprising several antennal elements arranged together in a linear array, wherein each of the several antennal elements comprises:
a waveguide comprising a conductive surface provided with at least one slot excited by propagation of a field in the waveguide, which delimits in its central part a conductive region and electrically insulates this region from the rest of the conductive surface, wherein the slot is annular.

8. The planar antenna as claimed in claim 7, comprising means for feeding the slotted guides with feed signals in parallel, wherein the means for feeding is arranged for steering phases between the feed signals of the slotted guides.
